(19) United States
(12) Patent Application Publication
(10) Pub. No.: US 2013/0246252 A1
(43) Pub. Date: Sep. 19, 2013

(54) Ezscrow

(71) Applicant: Steven A. Ludsin, East Hampton, NY (US)

(72) Inventor: Steven A. Ludsin, East Hampton, NY (US)

(21) Appl. No.: 13/554,452

(22) Filed: Sep. 18, 2012

Related U.S. Application Data
(60) Provisional application No. 61/574,364, filed on Jul. 22, 2011.

(51) Int. Cl. G06Q 40/02

(52) U.S. Cl. CPC G06Q 40/025
USPC 705/38

(57) ABSTRACT

This patent application is for the business process of Ezscrow. The business process seeks to protect governmental entities from counterparty risk by requiring good faith security deposits for government vendors. The funds will be administered by Ezscrow and held by a third party agent such as PayPal. The security deposits are based on the traditional security deposit provided by a tenant to a landlord. Ezscrow couples this security deposit with the electronic and computerized features of Ez-Pass. The unique and non-obvious aspect of Ezscrow is that the funds earn interest and are refundable if the government vendors are compliant and do not have outstanding delinquencies. The business process will provide advance enforcement designed to augment the current process that may include surety or performance bonds. The government entities will present the application for funds to Ezscrow which is the third party agent and also provides alternative dispute resolution.

### CROSS REFERENCE TO RELATED APPLICATIONS

The present application is a continuation of U.S. provisional patent application No. 61/574,364 entitled Ezscrow. It provides for “Systems and Methods Wherein an electronic interest bearing refundable security deposit facilitates a transaction by creating cash collateral in Which a Benefit is Applied in Exchange for Performance of a Task by a vendor” filed Jul. 22, 2011 and issued as U.S. Provisional Patent Application No. 61/574,364 on Jul. 22 2011, and claims the benefit of U.S. Provisional Application No. 61/574,364 entitled “Ezscrow” filed Jul. 22, 2011. The entire contents of these applications are incorporated herein by reference.

The present application is related to: U.S. provisional patent application No. 61/574,364 entitled “Ezscrow”. The entire contents of these applications are incorporated herein by reference.

### FIELD

The present invention relates to commerce. In particular, the present invention relates to systems and methods wherein a an electronic interest bearing refundable security deposit is used to facilitate a transaction by creating cash collateral by a government vendor to provide a responsibility fee fund. The same business process of creating instant cash collateral can be applicable to licensing and issuance of permits to provide a security for advance enforcement.

### BACKGROUND

Typically, a vendor responds to one or more government entities to provide for a products or services or services. When the vendor finds the products or services or services he or she is looking to provide, at a reasonable price, the vendor provides the products or services or services to the government entity. This traditional method, however, may require that the vendor visit a number of government entities to provide for the products or services or services the vendor will provide. Moreover, a government entity must attract vendors, such as by spending money on advertising for replies to the request for proposals. For example, when a government entity seeks providers for business or products or services, many vendors will know what types of products or services or services are sought by the government entity and reply successfully to the RFPs but the vendor does not provide cash collateral to create a privately funded responsibility fee fund as part of the contract for services or products or services. In addition, the traditional method does let the government entity, establish a pricing relationship directly with a vendor but there has not been a business process or utility that protects the government entity with instant cash collateral provided by the private sector vendor when the vendor performs the contract and commits fraud, non-performance or other acts that create damage due to the breach of contract by that vendor. For example, a manufacturer may sell a products or services or services to a government entity that ultimately determines that the products or services or services sold or provided by a vendor fails to meet the specifications. Ezscrow adds another layer of revenue that mitigates any damages due to poor performance or negligence on the part of the vendor providing the services or products or services. There would be a alternative dispute resolution to mediate any disputes which could include online dispute resolution. The analogy for the process is a fusion of the EZ Pass used on toll roads with the traditional interest bearing refundable security deposit provided in the landlord tenant lease.

Recently, products or services or services have been sold to vendors via communication networks such as the Internet. Internet provisions have been growing steadily over the past few years, and are expected to increase, because vendors are attracted to the ease and convenience of online access. For example, a vendor can provide online replies to requests for proposals or applicants for licenses or permits can access the information online and receive information from a number of Government entities to provide a products or services or services.

The provision of products or services or services from vendors to government entities that procure or provide licensing and permits, however, has a number of disadvantages. For example, in a typical provision via the Internet, a traditional government entity (e.g. a government entity which is not online) is typically left completely without cash collateral. Although there may be surety or performance bonds as well as holdback or retainage provisions, there has not been an actual security deposit that earns interest and would be refundable in the event that the vendor provides the services and products or services properly pursuant to the terms off the procurement contract. In addition to losing potential cash collateral reserves from the provision of the products or services or services itself, such a government entity loses the chance to protect against inadequate or shoddy products or services or services provided by the vendor, such as products or services or services accessories. This will still be a problem unless the government entity invests the time and money required to establish an online Ezscrow services to create cash collateral to augment adequate assurance of performance that meets specifications.

U.S. provisional patent application Application No. 61/574,364 filed Jul. 22, 2011 and entitled Ezscrow describes systems wherein a vendor provides a products or services or services to a government entity and simultaneously creates an Ezscrow account that indemnifies the government entity by hypothecating cash collateral. The Ezscrow system communicates with a vendor through a communication network to establish an interest bearing refundable security deposit for a products or services or services between the vendor and a government entity. For example, the Ezscrow system may enhance a vendor offer, including an offer price, related to the products or services or services. If the vendor offer is acceptable, the Ezscrow system arranges for the vendor to provide an interest bearing refundable security deposit when it provides the products or services or services to a government entity. The vendor provides a payment, based on an interest bearing refundable security deposit, to the Ezscrow system in exchange for the right to provide the products or services or services to the procuring government entity.

No matter what type of system is used to sell a products or services, some vendors may not be willing, or able, to pay an interest bearing refundable security deposit for the products or services. One way to address this problem is to increase the cost of the government contract associated with the products or services. Unfortunately, increasing the cost of the government contract also reduces any profit from the sale of the products or services, and the reduced profit may not be offset by any increase in the number of products or services that are sold.

Instead of simply increasing the cost of the government contract, a vendor may be given an extra credit score when the RFP reply is evaluated and discounts the price associated with the products or services to make the rfp reply more competitive if the vendor provides the Ezscrow interest bearing security deposit. This also reduces any profit with respect to those transactions in which a providing an interest bearing security deposit. Moreover, the discount associated with a coupon is traditionally revealed to government contractors, preventing the discount from being adjusted as appropriate (e.g., by increasing the discount if the coupon is not generating sales or by adjusting the discount based on information associated with a particular government contractor). In addition, the value of a coupon is generally determined when the coupon is provided to a government contractor, and not when the government contractor redeems the coupon. This also prevents the discount from being adjusted as may be appropriate (e.g., based on supply, demand or any other information at the time of redemption).

Instead of reducing the price associated with a products or services, it is also known that a vendor can offer a promotion to encourage a government contractor to purchase a products or services. For example, a vendor may advertise a “buy one get one free” promotion or provide a discount to government contractors who establish a credit card account associated with the vendor. Similarly, a number of vendors can work together to offer a promotion. For example, a first vendor may advertise that if a government contractor purchases a first products or services from the first vendor, a second products or services can be purchased at a reduced price from, or be given away by, a second vendor.

U.S. patent application Ser. No. 09/219,267 filed Dec. 23, 1998 and entitled “Method and Apparatus for Facilitating Electronic Commerce Through Providing Cross-Benefits During a Transaction” describes systems wherein a vendor server of a first vendor receives an indication of products or services that a government contractor is to purchase via a Web site. In response, the vendor server provides an offer for a benefit from a second vendor, such as by providing a cross-benefit or subsidy offer. If the government contractor indicates acceptance of the subsidy offer, the benefit is applied to the products or services or products or services being purchased. In exchange, the government contractor agrees to participate in a transaction with the second vendor.

However, the government contractor may not actually participate in the transaction with the second vendor as he or she agreed. For example, the vendor may forget to participate in the transaction or later change his or her mind about the agreement. In this case, the first vendor may want to recover the benefit that was applied to the products or services or products or services being purchased. However, the first vendor may not be able to locate the vendor or may be otherwise unable to recover the benefit from the vendor.

### SUMMARY

To alleviate problems inherent in the prior art, the present invention introduces systems and methods using a security deposit to facilitate a transaction.

According to one embodiment of the present invention, it is arranged for a benefit to be applied to a transaction in exchange for a future performance of a task by a vendor. The vendor provides a security deposit, and the security deposit is returned to the vendor based on the performance of the task.

According to another embodiment, an indication is received that a vendor is interested in Ezscrow an products or services from a vendor. Based on the received indication, an offer is transmitted to the vendor. The offer is to apply a benefit, provided by a subsidy provider, to the transaction in exchange for a future performance of a task by the vendor. A payment identifier is received from the vendor, and it is arranged for the vendor to provide payment of a security deposit using the payment identifier. The performance of the task by the vendor is verified, and the security deposit is returned to the vendor based on the performance of the task.

According to another embodiment, a security deposit is received from a vendor, and a subsidy amount is applied to a transaction in exchange for a future performance of a task by the vendor. Security deposit information is transmitted, the security deposit information enabling the vendor to receive the security deposit upon performance of the task.

According to another embodiment, a benefit is applied to a transaction in exchange for a future performance of a task by a vendor, the benefit being supplied by a subsidy provider. It is arranged for the vendor to provide a security deposit, and compensation is received in exchange for facilitating the transaction.

According to another embodiment, a vendor arranges to have a benefit applied to a transaction in exchange for a future performance of a task. A security deposit is provided (e.g., to a vendor), and the security deposit is returned based on the performance of the task.

One embodiment of the present invention comprises: means for arranging for a benefit to be applied to a transaction in exchange for a future performance of a task by a vendor; means for arranging for the vendor to provide a security deposit; and means for arranging for the security deposit to be returned to the vendor based on the performance of the task.

With these and other advantages and features of the invention that will become hereinafter apparent, the nature of the invention may be more clearly understood by reference to the following detailed description of the invention, the appended claims and the several drawings attached herein.

### DETAILED DESCRIPTION

The present invention is directed to systems and methods wherein a refundable interest bearing security deposit is used to facilitate a transaction, such as a transaction in which a government entity purchases products or services from a vendor. As used herein, products or services refer to anything that can be purchased or by a government entity (e.g., products or services and/or a services). Transportation equipment, consumer electronics, infrastructure projects, technical support services, and wide variety of products or services are some examples of products or services that can be purchased by a government entity. For example the State of New York procures $40 billion of good and services that comprise 1300 categories. Note that a government entity may instead purchase an interest in products or services (e.g., a government entity may lease a products or services from a vendor). Moreover, as used herein, a “government entity” or a “vendor” can be any party (e.g., an individual or a company) that exchanges products or services or an interest in products or services.

Turning now in detail to the concept, a flow chart of a transaction method according to an embodiment of the present invention would involve 3 parties: 1. the vendor who hypothecates the interest bearing refundable security deposit, 2. Ezscrow the intermediary that administers the security deposits and 3. the procuring government agency. It is arranged for a benefit to be applied to a transaction in exchange for a future performance of a task by a government entity. For example, the government entity may indicate to a vendor that he or she is interested in products or services by conditioning the contract on the creation of the privately funded Ezscrow security deposit. The vendor may then offer to provide the products or services to the government entity at a reduced price if the government entity accepts the benefit of the reserve fund created by Ezscrow.

The vendor may make such an offer, for example, because it enhances the financial stability of the procuring agency. Due to the second worst economic climate since the great depression, government entities such as town and cities are declaring bankruptcy due to a lack of revenues and a diminished borrowing capacity. The revenues available for enforcement against the vendors and other private sector entities will be provided by Ezscrow. The New York Times reported on Jul. 4, 2011 that the United States government is owed $65 billion form fraudsters, polluters, white-collar and corporate miscreants. Note that the payment into the Ezscrow fund provided by the vendor will reduce the exposure due to the facade of enforcement. The vendor is partially funding the reduction in enforcement revenues for the government entity). Also note that, according to one embodiment, there are surety and performance bonds posted by vendors as well contractual provisions that provide for holdback of a percentage of the payment for performance of the contract or retainage of the final payment. Ezscrow augments but does not preempt the existing embodiment.

1. A method of creating a cash collateral and alternative dispute resolution combined process to maintain the creditworthiness of a government vendor
a. Providing a format for said government vendor to deposit said cash collateral having connection with alternative dispute resolution in which said government must indicate a creditworthiness through escrowed cash,
b. instituting each of said creditworthiness escrow accounts and potential alternative dispute resolution in indicating a minimal credit ability to pay enforcement charges,
c. combining the escrow and alternative dispute resolution to compile an overall enforcement process for government vendors,
d. rejecting said government vendor if said cash collateral is below a predetermined value and accepting said government vendor if said cash collateral is above said predetermined value through the use of the combined computer process which performs the steps.
